(19) United States
(12) Patent Application Publication
(10) Pub. No.: US 2026/0158420 A1
(43) Pub. Date: Jun. 11, 2026

(54) SYSTEMS FOR FILTERING FINES FROM COKE PRODUCTS AND ASSOCIATED DEVICES AND METHODS

(71) Applicant: SUNCOKE TECHNOLOGY AND DEVELOPMENT LLC, Lisle, IL (US)

(72) Inventors: John Francis QUANCI, Haddonfield, NJ (US); Ashton COMPTON, Richlands, VA (US); Roy GRIFFEY, Grundy, VA (US)

(21) Appl. No.: 18/971,912

(22) Filed: Dec. 6, 2024

(51) Int. Cl. B01D 29/00; B01D 29/64

(52) U.S. Cl. CPC B01D 29/0097; B01D 29/6476; B01D 2258/0283; B01D 2279/00

(57) ABSTRACT

Systems for filtering fines from coke products, and associated devices and methods are disclosed herein. In some embodiments, an apparatus for filtering industrial products can include an excavating frame and a perforated plate fixedly coupled to the excavating frame. The excavating frame and the perforated plate can define a cavity for receiving industrial products therein. The perforated plate can include a plurality of apertures each having a dimension no more than 3.5 inches. The plurality of apertures can be arranged in columns such that a first subset of the apertures in a first column are offset from a second subset of the apertures in a second column adjacent to the first column.

### TECHNICAL FIELD

The present disclosure relates to an apparatus for filtering industrial product from a load of product and associated systems and methods. Some embodiments relate to systems, devices, and methods for filtering foundry coke using an excavating frame with a fixedly coupled perforated plate.

### BACKGROUND

Coke is a solid carbon fuel and carbon source used to melt and reduce iron ore in the production of steel. To make coke, finely crushed coal is fed into a coke oven and heated in an oxygen depleted, or anaerobic, environment under closely controlled atmospheric conditions. Such an environment drives off volatile compounds, such as hydrocarbons, tar, and gases, in the coal, leaving behind coke. For the majority of applications, coke needs to be of a certain minimum size to be effective. Generally, coke material smaller than 2 inches (e.g., fines) is undesirable, and thus efficient means of its removal from the coke product are desired.

The presence of fines in coke is undesirable for various reasons, including, but not limited to, reducing the efficiency and quality of the coke as a fuel source. Therefore, in order to preserve the quality of the coke, fines must be removed. Typically, the fines may be removed through a further screening process using large scale screeners, or a traditional excavating frame (e.g., a skeleton bucket). Removal of fines with the traditional excavating frame involves scooping a load of product from the coke pile and lifting the frame with a movable arm coupled to the frame. As the arm lifts and tilts the frame, fines falls through in between solid bars of the excavating frame and the larger-sized coke is retained within the frame. Although cost-effective when compared to adding more screeners, separating fines from coke by using the traditional excavating frame as a filter creates problems during the process. For example, the gaps between the solid bars of the traditional excavating frame can be plugged by the load of the coke or other industrial product to be filtered. This can create problems, such as the operator needing to physically remove the product plugging the gap between the solid bars. This can increase the amount of time it takes to successfully filter the fines from the coke pile.

### BRIEF DESCRIPTION OF THE DRAWINGS

Features, aspects, and advantages of the presently disclosed technology may be better understood with regard to the following drawings.

FIG. 1 is a front view of an excavating frame for filtering a load of industrial products and configured in accordance with the current embodiments of the technology.

FIGS. 2A and 2B are front and perspective views, respectively, of an excavating system including an excavating frame for filtering a load of industrial products, configured in accordance with embodiments of the present technology.

FIG. 3 is an enlarged front view of the excavating frame of FIG. 2A.

FIG. 4 is an enlarged side view of the excavating system of FIG. 2A.

FIGS. 5A and 5B are perspective views of the excavating system of FIG. 2A filtering a load of industrial products in accordance with embodiments of the present technology.

FIG. 6 is a flowchart illustrating a method for filtering industrial products in accordance with embodiments of the present technology.

A person skilled in the relevant art will understand that the features shown in the drawings are for purposes of illustrations, and variations, including different and/or additional features and arrangements thereof, are possible.

### DETAILED DESCRIPTION

### I. Overview

Embodiments of the present technology relate to systems for filtering a load of industrial products including coke products and fines, and associated devices and methods. Some examples relate to skeleton excavating frames (“excavating frames”) for scooping a pile of coke and other industrial products. To filter the pile of industrial products, some examples of excavating frames can include a series of support bars running lengthwise between a top portion and a bottom scooper of the excavating frame. The series of support bars can be further accompanied by at least one set of discretized bars running widthwise across the series of support bars. In some embodiments, the bottom scooper scoops the load of industrial products on the ground into the receiving area. An arm coupled to the excavating frame can lift the excavating frame upward, allowing the finer industrial product (“fines” or “coke breeze” or “breeze”) to separate from the larger industrial product (“coke product”) and pass through the openings between the support bars. However, during operation, the spacing between the solid bars of a traditional excavating frame can be plugged by the fines, thus preventing the fines from properly separating from the coke product.

Embodiments of the present technology address at least some of the above described issues. For example, embodiments of the present technology include an apparatus for filtering industrial products. The apparatus can include an excavating frame and a perforated plate fixedly coupled to the excavating frame. The excavating frame and the perforated plate define a cavity for receiving the industrial products therein. The perforated plate can include a plurality of apertures each having a dimension no more than 3.5 inches. The plurality of apertures can be arranged in columns such that a first subset of the apertures in a first column are offset, in a direction parallel to the columns, from a second subset of the apertures in a second column adjacent to the first column.

In some embodiments, an excavating system for filtering industrial products includes an arm, an excavating frame rotatably coupled to the arm, a perforated plate fixedly coupled to the excavating frame, and a stop block coupled to the arm. The excavating frame and the perforated plate can define a cavity for receiving the industrial products therein. The perforated plate can include a plurality of apertures each having a dimension no more than 3.5 inches. As the excavating frame rotates relative to the arm, the stop block can be configured to contact the excavating frame and create a jolt, thereby causing undersized materials of the industrial products to fall through the plurality of apertures.

In some embodiments, a method for filtering industrial products includes (i) collecting industrial products in an apparatus, the apparatus including an arm, an excavating frame, and a perforated plate, (ii) rotating the excavating frame, and (iii) abutting the excavating frame against the arm. The excavating frame can be rotatably coupled to the arm. The perforated plate can be fixedly coupled to the excavating frame, and can include a plurality of apertures each having a dimension no more than 4 inches. The excavating frame and the perforated plate can define a cavity for receiving the industrial products therein. The excavating frame can be rotated such that at least a subset of the apertures is positioned underneath the industrial products in the cavity, thereby causing a first portion of undersized materials of the industrial products to fall through the apertures. Abutting the excavating frame against the arm can create a jolt and cause a second portion of the undersized materials of the industrial products to fall through the apertures.

In the figures, identical or similar reference numbers identify generally similar, and/or identical, elements. Many of the details, dimensions, and other features shown in the Figures are merely illustrative of particular embodiments of the disclosed technology. Accordingly, other embodiments can have other details, dimensions, and features without departing from the spirit or scope of the disclosure. In addition, those of ordinary skill in the art will appreciate that further embodiments of the various disclosed technologies can be practiced without several of the details described below.

### II. Select Embodiments of an Excavating Frame for Filtering a Load of Industrial Products

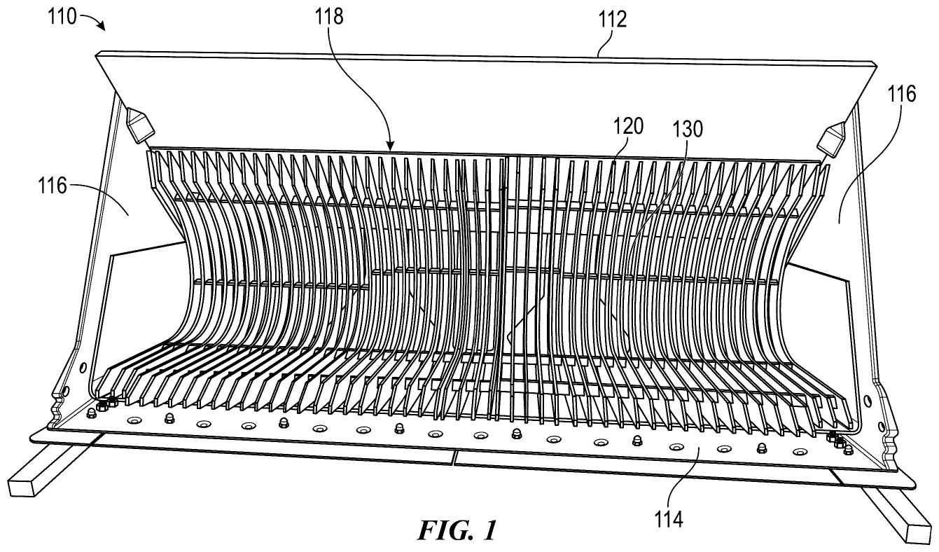

FIG. 1 is a front view of an excavating frame 110 for filtering a load of industrial products and configured in accordance with embodiments of the present technology. The excavating frame 110 can include a top portion 112, a bottom scooper portion 114, and two end member portions 116 each extending therebetween at the sides thereof. The excavating frame 110 can further include a series of support bars 120 running lengthwise (e.g., vertically) between the top portion 112 and the bottom scooper portion 114, and at least one set of discretized bars 130 running widthwise (e.g., laterally) between the series of support bars 120. The top portion 112, the bottom scooper portion 114, the two end member portions 116, and the support bars 120 can define a cavity 118 for receiving industrial products. In operation, the bottom scooper portion 114 can scoop a load of industrial products into the cavity 118. The top portion 112 and the bottom scooper portion 114 can be coupled to the two end member portions 116 by fasteners (e.g., screws, nuts, bolts), welding, and/or the like.

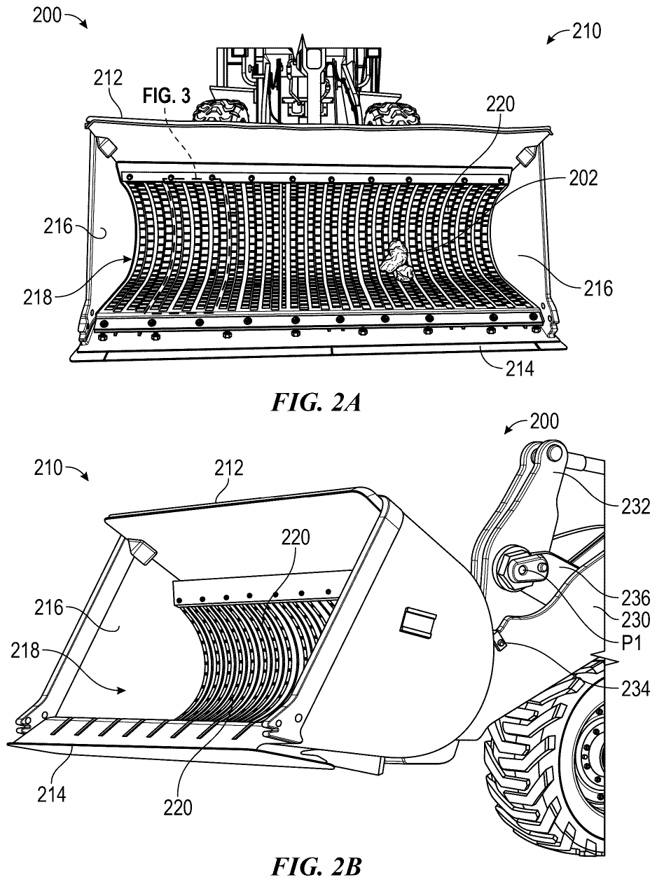

FIGS. 2A and 2B are front and perspective views, respectively, of an excavating system 200 for filtering a load of industrial products 202 (e.g., coke and fines) and configured in accordance with embodiments of the present technology. Referring to FIGS. 2A and 2B together, the excavating system 200 can include an excavating frame 210 and a perforated plate 220 coupled thereto. The excavating frame 210 can include a top portion 212, a bottom scooper portion 214, and two end member portions 216 extending therebetween at the sides thereof. The perforated plate 220 can be coupled to each of the top portion 212 and the bottom scooper portion 214 via fasteners, welding, and/or the like.

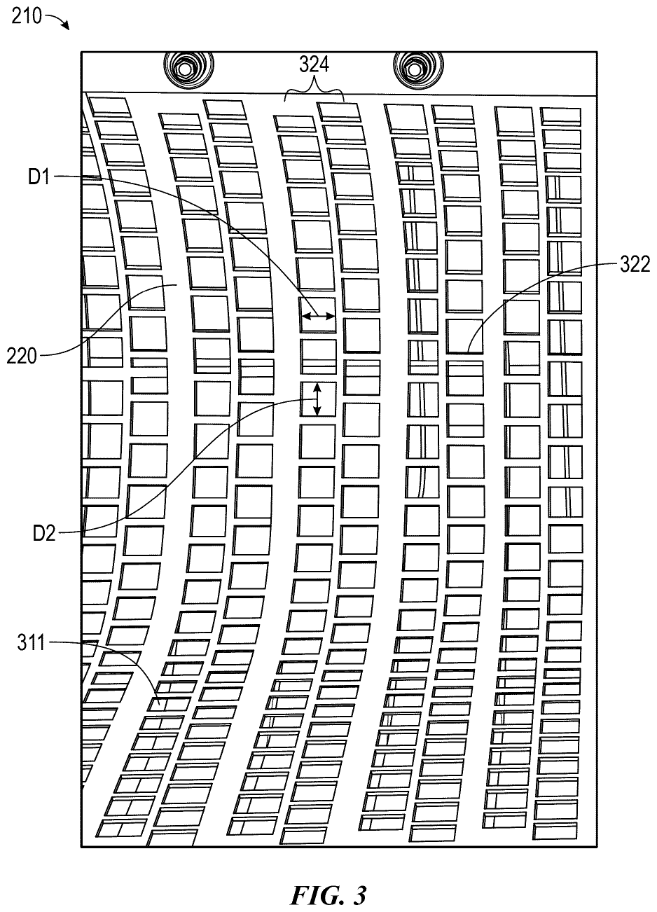

In the illustrated embodiment, the perforated plate 220 has a curved or curvilinear form factor such that the concave side of the perforated plate 220 faces the front of the excavating frame 210. The excavating frame 210 and the perforated plate 220 can define a cavity 218 for receiving industrial products 202 (FIG. 2A) therein. In some embodiments, the excavating frame 210 further includes support vanes (not shown in FIGS. 2A and 2B; shown in FIG. 3) positioned to the rear of the perforated plate 220. The perforated plate 220 is described in further detail herein with reference to FIG. 3.

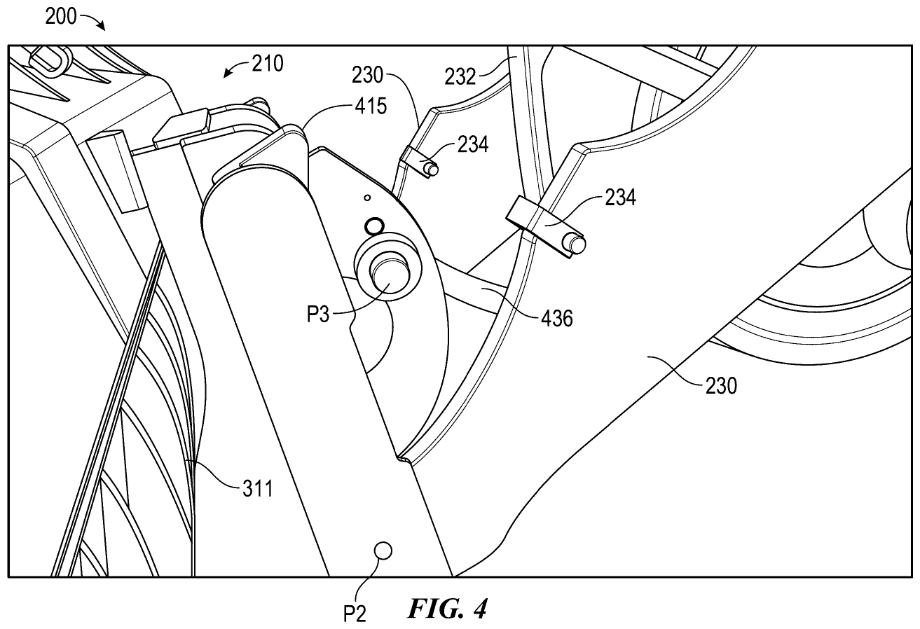

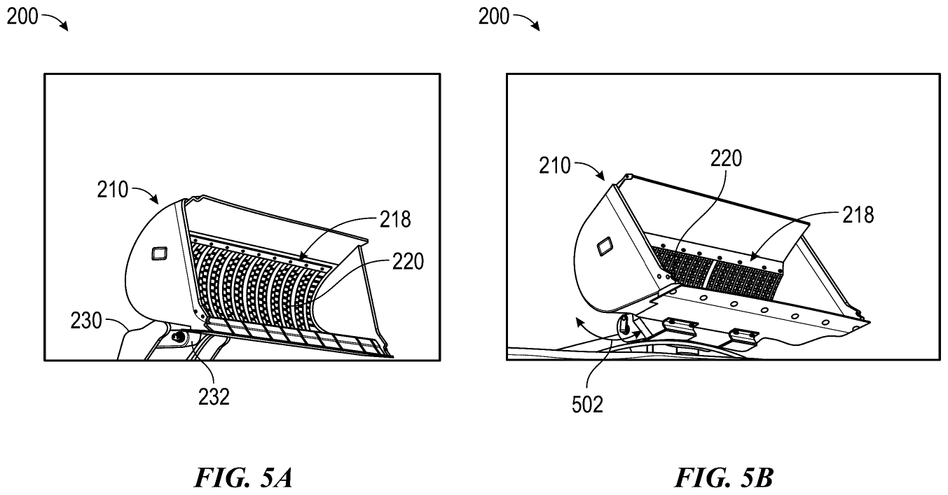

Referring to FIG. 2B, the excavating system 200 can further include an arm 230 coupled to a rear side of the excavating frame 210, an extension 236, a rotating head 232 rotatably coupled to the extension 236 at pivot P1 and operably coupled to the rear side of the excavating frame 210, and one or more stop blocks 234 coupled to the arm 230. The arm 230 can support most of the weight of the excavating frame 210, and as discussed in further detail herein, the rotating head 232 can be rotated about the pivot P1 to rotate the excavating frame 210 relative to the arm 230. The arm 230 and the rotating head 232 are described in further detail herein with reference to FIGS. 4-5B.

FIG. 3 is an enlarged front view of the perforated plate 220 (within the dotted box labeled “FIG. 3” in FIG. 2A). The perforated plate 220 can include a curvilinear sheet metal with a plurality of apertures 322 arranged substantially along the entire surface area of the perforated plate 220. In particular, in the illustrated embodiment, the apertures 322 are rectangular-shaped apertures arranged in pairs of columns 324, each column extending generally between the top and bottom of the perforated plate 220. The gap between the two columns in each pair of columns 324 can be smaller than the gap between adjacent pairs of columns 324. Each column can include a plurality of the apertures 322 aligned along the column and generally equally spaced apart from one another. Moreover, the apertures 322 in a first column of each pair of columns 324 can be offset from the apertures 322 in a second column of the pair of columns 324. For example, the apertures 322 in the first column of each pair of columns 324 can be vertically offset and/or offset in a direction substantially parallel to the columns from the apertures 322 in the second column of the pair of columns 324. The term “substantially parallel,” as used herein, shall mean that the two directions or axes are perfectly parallel or at an angle no greater than 10 degrees. In other words, individual rows associated with the apertures 322 in the first column at least partially overlap with two adjacent rows associated with the apertures 322 in the second column. In some embodiments, the first column is immediately adjacent to the second column. Each aperture 322 can have a lateral dimension D1 and a vertical dimension D2, each of which can be no more than 0.5 inch, 1 inch, 2 inches, 3 inches, 4 inches, 5 inches, 6 inches, or between 0.5-6 inches (or any value therebetween, e.g., 3.5 inches).

The excavating frame 210 can further include a plurality of support vanes 311 positioned at a rear side of the perforated plate 220 to support the perforated plate 220. For example, the support vanes 311 can extend (i) between the top portion 212 and the bottom scooper portion 214 and/or (ii) between the two end member portions 216 and contact the rear side of the perforated plate 220 to, e.g., prevent bending of the perforated plate 220 during operation of the excavating system 200. In particular, the support vanes 311 can be positioned to avoid extending across, and thus at least partially covering, the apertures 322. In other words, the support vanes 311 can be positioned along the gaps between the apertures 322 (e.g., between different ones of the pairs of columns 324).

It is appreciated that while FIG. 3 illustrates the apertures 322 having a particular shape (e.g., rectangular) and arranged in a particular arrangement (e.g., in the pairs of columns 324), the apertures 322 can have different shapes and/or be arranged in a different arrangement across the perforated plate 220. Also, different ones of the apertures 322 can have different shapes and/or sizes. The particular shape, size, and arrangement of the apertures 322 can be selected depending on, e.g., the industrial products to be filtered.

FIG. 4 is an enlarged side view of the excavating system 200. As shown, left and right portions of the arm 230 are coupled to the rear side of the excavating frame 210 at pivots P2. The rotating head 232 is positioned between the left and right portions of the arm 230, and a strut 436 is rotatably coupled to (i) the rotating head 232 at a pivot not shown (obscured by the arm 230) and (ii) the rear side of the excavating frame 210 at pivot P3. Two stop blocks 234 are illustrated, each coupled to the upper portion of a corresponding one of the left or right portions of the arm 230. The stop blocks 234 can be composed of metal, rubber, or other suitable material, and can be coupled to the arm 230 via fasteners, welding, and/or the like. In the illustrated embodiment, the stop blocks 234 each includes a bracket. The rear side of the excavating frame 210 can include one or more rearward protrusions 415.

Referring to FIGS. 2-4 together, in operation, the arm 230 can be maneuvered such that the bottom scooper portion 214 scoops up industrial products from a surface (e.g., a mixed pile of coke and fines on the ground) and the industrial products are collected in the cavity 218 of the excavating frame 220. The arm 230 can then be raised to a higher elevation, as illustrated in FIG. 5A. In particular, the excavating frame 210 can be raised in a manner such that the opening of the cavity 218 continues to face forward. Subsequently, the rotating head 232 can rotate about the pivot P1 in a counterclockwise direction (as seen in FIG. 2B), thereby pulling the strut 436 in a direction away from the excavating frame 210. The strut 436 then pulls on the excavating frame 210 (at the pivot P3) to rotate the excavating frame 210 about the pivots P2 in a clockwise direction (as seen in FIG. 4) such that the opening of the cavity 218 faces upward, as illustrated in FIG. 5B.

Once the excavating frame 210 is in the orientation illustrated in FIG. 5B, the apertures 322 of the perforated plate 220 can be positioned generally below the industrial products collected in the cavity 218. Therefore, materials among the industrial products having a size less than the dimensions of the apertures 322 (e.g., fines, breeze) can fall through the apertures 322, and materials among the industrial products having a size greater than the dimensions of the apertures 322 (e.g., coke products) can remain in the cavity 218. The undersized materials (e.g., fines, breeze) can be allowed to fall to the ground or into a collector (e.g., a bucket, a tray), and the oversized materials (e.g., coke products) remaining on the excavating frame 210 can be transported for further processing and/or for sale to customers.

In some embodiments, as the excavating frame 210 rotates about the pivots P2, the rearward protrusions 415 on the excavating frame 210 can hit, abut against, or otherwise come into contact with corresponding ones of the stop blocks 234. The impact between the rearward protrusions 415 and the stop blocks 234 can create a jolt, such as to abruptly stop the rotation of the excavating frame 210 or cause the excavating frame 210 to bounce off the stop blocks 234 and at least momentarily rotate in the opposite direction. The jolt can cause additional undersized materials that may be remaining in the cavity 218 to fall through the apertures 322, enabling a higher degree of filtering of the industrial products. In some embodiments, the excavating system 200 omits the rearward protrusions 415 and/or the stop blocks 234, and instead, e.g., a different part of the excavating frame 210 can hit the arm 230 directly. In some embodiments, once the rearward protrusions 415 hit the stop blocks 234, the rotating head 232 can rotate in the opposite direction to reset the orientation of the excavating frame 210 (e.g., to the orientation illustrated in FIG. 5A), and the rotating head 232 can rotate again to create another jolt. This process can be repeated any number of times to cause jolts any number of times until, e.g., a desired degree of filtering is achieved. For example, at least 70%, 80%, 90%, 95%, 99%, or 70-99% of the fines can be separated from the larger coke products.

In some embodiments, filtering industrial products in accordance with embodiments of the present technology is expected to reduce the average ash content of the screened industrial products. This may be attributable to fines or breeze generally having higher ash content than coke products. For example, fines or breeze may have an ash content of about 20% by weight, and coke products may have an ash content of about 8% by weight. If the original pile of industrial products included a blend of 5% fines or breeze and 95% blast-size coke, the original pile of industrial products may have an average ash content of about 8.6%. Once screened using the excavating system 200 (or other systems configured in accordance with embodiments of the present technology), assuming a near 100% removal of the fines or breeze, the screened industrial products will include just the blast-size coke, and thus an average ash content of 8%.

Compared to other devices, excavating frames configured in accordance with embodiments of the present technology are expected to more efficiently and effectively filter industrial products with a lower risk of clogging any openings in the device (e.g., the apertures 322). In some embodiments, the amount of industrial products scooped up is controlled to maximize the efficiency of the subsequent filtering. For example, scooping up an excessive quantity of industrial products can cause some of the undersized materials to fail to fall through the apertures 322 due to the large amount of the industrial products blocking their path. Conversely, scooping up a small quantity of industrial products can require additional iterations of the scooping and filtering processes described herein.

### III. Select Embodiments of a Method for Filtering Industrial Products

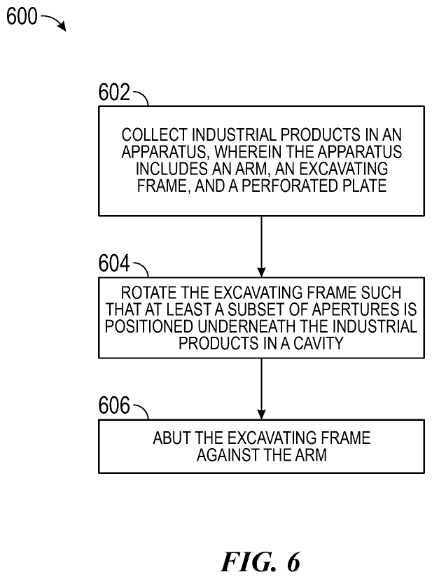

FIG. 6 is a flowchart illustrating a method 600 for filtering industrial products in accordance with embodiments of the present technology. While the steps of the method 600 are described below in a particular order, one or more of the steps can be performed in a different order or omitted, and the method 600 can include additional and/or alternative steps. Additionally, although the method 600 may be described below with reference to the embodiments of the present technology described herein, the method 600 can be performed with other embodiments of the present technology.

The method 600 can include collecting industrial products in an apparatus, wherein the apparatus include an arm, an excavating frame, and a perforated plate (process portion 602). The excavating frame can be rotatably coupled to the arm. The perforated plate can be fixedly coupled to the excavating frame, and can include a plurality of apertures each having a dimension no more than 6 inches, 5 inches, 4 inches, 3 inches, 2 inches, 1 inch, 0.5 inch, or between 0.5-6 inches. The excavating frame and the perforated plate can define a cavity for receiving the industrial products therein. In some embodiments, collecting comprises scooping the industrial products into the cavity using the excavating frame.

The method 600 can also include rotating the excavating frame such that at least a subset of the apertures is positioned underneath the industrial products in the cavity (process portion 604). This can cause a first portion of undersized materials (e.g., fines) of the industrial products to fall through the apertures. In some embodiments, the method 600 includes, prior to rotating the excavating frame, lifting the excavating frame to a higher elevation. Lifting the excavating frame may automatically cause the rotation of the excavating frame. In some embodiments, the industrial products further include coke products, and rotating the excavating frame comprises retaining the coke products in the cavity of the apparatus.

The method 600 can further include abutting the excavating frame against the arm (process portion 606). This can create a jolt and cause a second portion of the undersized materials (e.g., additional fines) of the industrial products to fall through the apertures. In some embodiments, the apparatus further includes a stop block coupled to the arm and/or the excavating frame includes a rearward protrusion, and abutting comprises abutting the excavating frame/rearward protrusion against the arm/stop block.

### IV. Examples

The present technology is illustrated, for example, according to various aspects described below as numbered examples (1, 2, 3, etc.) for convenience. These are provided as examples and do not limit the present technology. It is noted that any of the dependent examples may be combined in any combination, and placed into a respective independent example. The other examples can be presented in a similar manner.

1. An apparatus for filtering industrial products, the apparatus comprising:
an excavating frame; and
a perforated plate fixedly coupled to the excavating frame,
wherein the excavating frame and the perforated plate define a cavity for receiving the industrial products therein,
wherein the perforated plate includes a plurality of apertures each having a dimension no more than 3.5 inches, and
wherein the plurality of apertures is arranged in columns such that a first subset of the apertures in a first column is offset from a second subset of the apertures in a second column adjacent to the first column.

2. The apparatus of any one of the clauses herein, wherein the first subset of the apertures in the first column is offset, in a direction substantially parallel to the columns, from the second subset of the apertures in the second column.

3. The apparatus of any one of the clauses herein, wherein the second column is immediately adjacent to the first column.

4. The apparatus of any one of the clauses herein, wherein individual rows associated with the first subset of the apertures in the first column at least partially overlap with two adjacent rows associated with the second subset of the apertures in the second column.

5. The apparatus of any one of the clauses herein, wherein the perforated plate has a curvilinear shape, and wherein a concave side of the perforated plate faces the cavity.

6. The apparatus of any one of the clauses herein, wherein the plurality of apertures are arranged in pairs of columns such that a first gap between two columns in a pair of columns is smaller than a second gap between adjacent pairs of columns.

7. The apparatus of any one of the clauses herein, wherein the excavating frame includes a plurality of support vanes extending along a rear side of the perforated plate and along gaps between adjacent pairs of columns.

8. The apparatus of any one of the clauses herein, wherein individual ones of the plurality of apertures have rectangular shapes.

9. The apparatus of any one of the clauses herein, wherein individual ones of the plurality of apertures have a dimension no more than 2 inches.

10. The apparatus of any one of the clauses herein, wherein the apparatus is configured to filter fines from coke products having a dimension of at least 3.5 inches.

11. An excavating system for filtering industrial products, the excavating system comprising:
an arm;
an excavating frame rotatably coupled to the arm;
a perforated plate fixedly coupled to the excavating frame, wherein the excavating frame and the perforated plate define a cavity for receiving the industrial products therein, and wherein the perforated plate includes a plurality of apertures each having a dimension no more than 3.5 inches; and
a stop block coupled to the arm, such that, as the excavating frame rotates relative to the arm, the stop block directly or indirectly contacts the excavating frame.

12. The excavating system of any one of the clauses herein, wherein the excavating frame includes a rearward protrusion configured to contact the stop block as the excavating frame rotates relative to the arm.

13. The system of any one of the clauses herein, further comprising a rotating head operably coupled to the excavating frame, wherein the rotating head is configured to rotate the excavating frame relative to the arm.

14. The system of any one of the clauses herein, wherein the arm includes a left arm portion and a right arm portion spaced apart from the left arm portion, and wherein the rotating head is positioned between the left arm portion and the right arm portion.

15. The system of any one of the clauses herein, wherein the arm includes a left arm portion and a right arm portion spaced apart from the left arm portion, wherein the stop block is a first stop block coupled to the left arm portion, wherein the system further comprises a second stop block coupled to the right arm portion, and wherein the excavating frame includes (i) a first rearward protrusion configured to, as the excavating frame rotates relative to the arm, contact the first stop block and (ii) a second rearward protrusion configured to, as the excavating frame rotates relative to the arm, contact the second stop block.

16. The system of any one of the clauses herein, wherein the plurality of apertures are arranged in columns such that a first subset of the apertures in a first column are offset, in a direction substantially parallel to the columns, from a second subset of the apertures in a second column adjacent to the first column.

17. The system of any one of the clauses herein, wherein the plurality of apertures are arranged in pairs of columns such that a first gap between two columns in a pair of columns is smaller than a second gap between adjacent pairs of columns.

18. A method for filtering industrial products, the method comprising:
collecting industrial products in an apparatus, wherein the apparatus includes:
   an arm;
   an excavating frame rotatably coupled to the arm; and
   a perforated plate fixedly coupled to the excavating frame, wherein the perforated plate includes a plurality of apertures each having a dimension no more than 4 inches,
   wherein the excavating frame and the perforated plate define a cavity for receiving the industrial products therein;
rotating the excavating frame such that at least a subset of the apertures is positioned underneath the industrial products in the cavity, thereby causing a first portion of undersized materials of the industrial products to fall through the apertures; and
abutting the excavating frame against the arm, thereby creating a jolt and causing a second portion of the undersized materials of the industrial products to fall through the apertures.

19. The method of any one of the clauses herein, wherein the apparatus further includes a stop block coupled to the arm, and wherein abutting comprises abutting the excavating frame against the stop block.

20. The method of any one of the clauses herein, wherein the apparatus further includes a stop block coupled to the arm, wherein the excavating frame includes a rearward protrusion, and wherein abutting comprises abutting the rearward protrusion against the stop block.

21. The method of any one of the clauses herein, further comprising lifting, prior to rotating, the excavating frame to a higher elevation.

22 The method of any one of the clauses herein, wherein the undersized materials of the industrial products include fines, wherein the industrial products further include coke products, and wherein rotating the excavating frame comprises retaining the coke products in the cavity of the apparatus.

23. An apparatus configured to filter industrial product from a load of product, the apparatus comprising:
an excavating frame including end members and a plurality of support bars; and
a perforated plate fixedly coupled to the excavating frame and disposed between the end members of the excavating frame, such that the perforated plate and the end members define a receiving area configured to receive the load of product, wherein the perforated plate includes a plurality of openings having a maximum dimension of no more than 3.5″.

24. The apparatus of any one of the clauses herein, wherein the maximum dimension is no more than 3″, 2.5″, 2.0″, 1.5″, 1.0″, or 0.5″.

25 The apparatus of any one of the clauses herein, wherein the perforated plate includes multiple identical arrays that each include the openings, individual arrays including a solid portion extending from a first end portion of the perforated plate to a second end portion of the perforated plate opposite the first end portion.

26. The apparatus of any one of the clauses herein, wherein the perforated plate includes a plurality of solid portions extending from a first end portion of the perforated plate to a second end portion of the perforated plate opposite the first end portion.

27. The apparatus of any one of the clauses herein, wherein the perforated plate includes a solid portion extending from a first end portion of the perforated plate to a second end portion of the perforated plate opposite the first end portion, and wherein some of the plurality of openings abut the solid portion.

28 The apparatus of any one of the clauses herein, wherein the perforated plate includes a first solid portion and a second solid portion spaced apart from the first solid portion, wherein the first and second solid portions each extend from a first end portion of the perforated plate to a second end portion of the perforated plate opposite the first end portion, and wherein some of the plurality of openings are between the first and second solid portions.

29. The apparatus of any one of the clauses herein, wherein the end members are spaced apart from one another along a first direction and the support bars extend in a second direction normal or angled to the first direction, and wherein the plurality of openings includes a first group of openings, and a second group of openings that (i) abut the second group of openings and (ii) are offset from the first group along the second direction.

30. The apparatus of any one of the clauses herein, wherein the industrial product includes coke coal having an average maximum dimension of at least 3.5″ and fines having a maximum dimension less than a predetermined size.

31. A system for filtering industrial product from a load of product, comprising:
an excavating frame including end members and a plurality of support bars;
an arm coupled to the excavating frame and configured to rotate the excavating frame about a first axis and move the excavating frame along a second axis;
a perforated plate fixedly coupled to the excavating frame and disposed between the end members of the excavating frame, such that the perforated plate and end members define a receiving area configured to receive the load of product, wherein the perforated plate includes a plurality of openings having a maximum dimension of no more than 3.5″; and
at least one stop coupled to the arm.

32. The system of any one of the clauses herein, wherein a rotating head is coupled to the excavating frame.

33. The system of any one of the clauses herein, wherein the rotating head is further coupled to the arm.

34. The system of any one of the clauses herein, wherein the arm is further coupled to an excavating machine.

35. The system of any one of the clauses herein, wherein the at least one stop is positioned on the arm in parallel to the rotating head.

36 The system of any one of the clauses herein, wherein lifting the arm engages the rotating head.

37. A method for filtering industrial product from a load of product, the method comprising:
providing an apparatus including a receiving area defined by end members of an excavating frame and a perforated plate coupled to the excavating frame, wherein the perforated plate includes a plurality of openings having a maximum dimension of no more than 3.5″;
filling the receiving area with industrial product; and
rotating the perforated plate via a rotating head anchored to the apparatus, thereby causing some of the product to fall through the openings.

38 The method of any one of the clauses herein, wherein at least one stop is positioned on an arm in parallel to the rotating head.

39. The method of any one of the clauses herein, wherein lifting the arm engages the rotating head.

40. The method of any one of the clauses herein, wherein the product includes coke having an average maximum dimension of at least 3.5″ and fines having a maximum dimension less than a predetermined size.

41. The method of any one of the clauses herein, wherein a contact between the excavating frame and the at least one stop creates a jolt.

42 The method of any one of the clauses herein, wherein the jolt creates a contact between the industrial product and the perforated plate.

43. The method of any one of the clauses herein, wherein the jolt causes some of the industrial product to fall through the openings of the perforated plate.

### V. Conclusion

It will be apparent to those having skill in the art that changes may be made to the details of the above-described embodiments without departing from the underlying principles of the present disclosure. In some cases, well known structures and functions have not been shown or described in detail to avoid unnecessarily obscuring the description of the embodiments of the present technology. Although steps of methods may be presented herein in a particular order, alternative embodiments may perform the steps in a different order. Similarly, certain aspects of the present technology disclosed in the context of particular embodiments can be combined or eliminated in other embodiments. Furthermore, while advantages associated with certain embodiments of the present technology may have been disclosed in the context of those embodiments, other embodiments can also exhibit such advantages, and not all embodiments need necessarily exhibit such advantages or other advantages disclosed herein to fall within the scope of the technology. Accordingly, the disclosure and associated technology can encompass other embodiments not expressly shown or described herein, and the invention is not limited except as by the appended claims.

Where the context permits, singular or plural terms may also include the plural or singular term, respectively. For example, throughout this disclosure, the singular terms “a,” “an,” and “the” include plural referents unless the context clearly indicates otherwise. Moreover, unless the word “or” is expressly limited to mean only a single item exclusive from the other items in reference to a list of two or more items, then the use of “or” in such a list is to be interpreted as including (a) any single item in the list, (b) all of the items in the list, or (c) any combination of the items in the list. Furthermore, as used herein, the phrase “and/or” as in “A and/or B” refers to A alone, B alone, and both A and B. Additionally, the terms “comprising,” “including,” “having,” and “with” are used throughout to mean including at least the recited feature(s) such that any greater number of the same features and/or additional types of other features are not precluded. Moreover, as used herein, the phrases “based on,” “depends on,” “as a result of,” and “in response to” shall not be construed as a reference to a closed set of conditions. For example, a step that is described as “based on condition A” may be based on both condition A and condition B without departing from the scope of the present disclosure. In other words, as used herein, the phrase “based on” shall be construed in the same manner as the phrase “based at least in part on” or the phrase “based at least partially on.”

Reference herein to “one embodiment,” “an embodiment,” “some embodiments” or similar formulations means that a particular feature, structure, operation, or characteristic described in connection with the embodiment can be included in at least one embodiment of the present technology. Thus, the appearances of such phrases or formulations herein are not necessarily all referring to the same embodiment. Furthermore, various particular features, structures, operations, or characteristics may be combined in any suitable manner in one or more embodiments.

Unless otherwise indicated, all numbers expressing numerical values used in the specification and claims, are to be understood as being modified in all instances by the term “about.” Accordingly, unless indicated to the contrary, the numerical parameters set forth in the specification and attached claims are approximations that may vary depending upon the desired properties sought to be obtained by the present technology. At the very least, and not as an attempt to limit the application of the doctrine of equivalents to the scope of the claims, each numerical parameter should at least be construed in light of the number of reported significant digits and by applying ordinary rounding techniques. Additionally, all ranges disclosed herein are to be understood to encompass any and all subranges subsumed therein. For example, a range of “1 to 10” includes any and all subranges between (and including) the minimum value of 1 and the maximum value of 10 (e.g., any and all subranges having a minimum value of equal to or greater than 1 and a maximum value of equal to or less than 10, such as 5.5 to 10).

The disclosure set forth above is not to be interpreted as reflecting an intention that any claim or example requires more features than those expressly recited in that claim or example. Rather, as the preceding examples and the following claims reflect, inventive aspects lie in a combination of fewer than all features of any single foregoing disclosed embodiment. Thus, the preceding examples and the following claims are hereby expressly incorporated into the Detailed Description, with each claim standing on its own as a separate embodiment. This disclosure includes all permutations of the independent claims with their dependent claims.

What is claimed is:

1. An apparatus for filtering industrial products, the apparatus comprising:
an excavating frame; and
a perforated plate fixedly coupled to the excavating frame,
wherein the excavating frame and the perforated plate define a cavity for receiving the industrial products therein,
wherein the perforated plate includes a plurality of apertures each having a dimension no more than 3.5 inches, and
wherein the plurality of apertures is arranged in columns such that a first subset of the apertures in a first column is offset from a second subset of the apertures in a second column adjacent to the first column.

2. The apparatus of claim 1, wherein the first subset of the apertures in the first column is offset, in a direction substantially parallel to the columns, from the second subset of the apertures in the second column.

3. The apparatus of claim 1, wherein the second column is immediately adjacent to the first column.

4. The apparatus of claim 1, wherein individual rows associated with the first subset of the apertures in the first column at least partially overlap with two adjacent rows associated with the second subset of the apertures in the second column.

5. The apparatus of claim 1, wherein the perforated plate has a curvilinear shape, and wherein a concave side of the perforated plate faces the cavity.

6. The apparatus of claim 1, wherein the plurality of apertures are arranged in pairs of columns such that a first gap between two columns in a pair of columns is smaller than a second gap between adjacent pairs of columns.

7. The apparatus of claim 6, wherein the excavating frame includes a plurality of support vanes extending along a rear side of the perforated plate and along gaps between adjacent pairs of columns.

8. The apparatus of claim 1, wherein individual ones of the plurality of apertures have rectangular shapes.

9. The apparatus of claim 1, wherein individual ones of the plurality of apertures have a dimension no more than 2 inches.

10. The apparatus of claim 1, wherein the apparatus is configured to filter fines from coke products having a dimension of at least 3.5 inches.

11. An excavating system for filtering industrial products, the excavating system comprising:
an arm;
an excavating frame rotatably coupled to the arm;
a perforated plate fixedly coupled to the excavating frame, wherein the excavating frame and the perforated plate define a cavity for receiving the industrial products therein, and wherein the perforated plate includes a plurality of apertures each having a dimension no more than 3.5 inches; and
a stop block coupled to the arm, such that, as the excavating frame rotates relative to the arm, the stop block directly or indirectly contacts the excavating frame.

12. The excavating system of claim 11, wherein the excavating frame includes a rearward protrusion configured to contact the stop block as the excavating frame rotates relative to the arm.

13. The system of claim 11, further comprising a rotating head operably coupled to the excavating frame, wherein the rotating head is configured to rotate the excavating frame relative to the arm.

14. The system of claim 13, wherein the arm includes a left arm portion and a right arm portion spaced apart from the left arm portion, and wherein the rotating head is positioned between the left arm portion and the right arm portion.

15. The system of claim 11, wherein the arm includes a left arm portion and a right arm portion spaced apart from the left arm portion, wherein the stop block is a first stop block coupled to the left arm portion, wherein the system further comprises a second stop block coupled to the right arm portion, and wherein the excavating frame includes (i) a first rearward protrusion configured to, as the excavating frame rotates relative to the arm, contact the first stop block and (ii) a second rearward protrusion configured to, as the excavating frame rotates relative to the arm, contact the second stop block.

16. The system of claim 11, wherein the plurality of apertures are arranged in columns such that a first subset of the apertures in a first column are offset, in a direction substantially parallel to the columns, from a second subset of the apertures in a second column adjacent to the first column.

17. The system of claim 11, wherein the plurality of apertures are arranged in pairs of columns such that a first gap between two columns in a pair of columns is smaller than a second gap between adjacent pairs of columns.

18. A method for filtering industrial products, the method comprising:
collecting industrial products in an apparatus, wherein the apparatus includes:
an arm;
an excavating frame rotatably coupled to the arm; and
a perforated plate fixedly coupled to the excavating frame, wherein the perforated plate includes a plurality of apertures each having a dimension no more than 4 inches,
wherein the excavating frame and the perforated plate define a cavity for receiving the industrial products therein;
rotating the excavating frame such that at least a subset of the apertures is positioned underneath the industrial products in the cavity, thereby causing a first portion of undersized materials of the industrial products to fall through the apertures; and
abutting the excavating frame against the arm, thereby creating a jolt and causing a second portion of the undersized materials of the industrial products to fall through the apertures.

19. The method of claim 18, wherein the apparatus further includes a stop block coupled to the arm, and wherein abutting comprises abutting the excavating frame against the stop block.

20. The method of claim 18, wherein the apparatus further includes a stop block coupled to the arm, wherein the excavating frame includes a rearward protrusion, and wherein abutting comprises abutting the rearward protrusion against the stop block.

21. The method of claim 18, further comprising lifting, prior to rotating, the excavating frame to a higher elevation.

22. The method of claim 18, wherein the undersized materials of the industrial products include fines, wherein the industrial products further include coke products, and wherein rotating the excavating frame comprises retaining the coke products in the cavity of the apparatus.
